(19) United States
(12) Patent Application Publication
(10) Pub. No.: US 2008/0207053 A1
(43) Pub. Date: Aug. 28, 2008

(54) USB connector housing

(76) Inventors: Chih-Ming Lin, Taichung (TW); Chin-Tsai Shih, Tai-Ping City (TW)

Correspondence Address: JACOBSON HOLMAN PLLC, 400 SEVENTH STREET N.W., SUITE 600, WASHINGTON, DC, 20004, US

(21) Appl. No.: 11/882,534

(22) Filed: Aug. 2, 2007

(30) Foreign Application Priority Data
Feb. 26, 2007 (TW) 096106473

(51) Int. Cl. H01R 13/648

(52) U.S. Cl. 439/607

(57) ABSTRACT

A USB connector housing includes: a hollow main body; a guiding pin extending from the main body; and an engaging member extending from the main body and including a pair of opposite engaging pins adapted to extend through an engaging hole in a board. Each of the engaging pins has a leg portion extending from the main body, a body portion extending from the leg portion and adapted to abut against a hole defining wall of the engaging hole in the board, a neck portion extending from the body portion, and a head portion enlarged in cross-section from the neck portion. The head portion of each of the engaging pins has an anchor end adapted for anchoring at a periphery of the engaging hole in the board. The anchor end of the head portion has a width greater than those of the neck portion and the body portion.

### CROSS-REFERENCE TO RELATED APPLICATION

This application claims priority of Taiwanese Application No. 096106473, filed on Feb. 26, 2007.

### BACKGROUND OF THE INVENTION

1. Field of the Invention

The invention relates to a USB (Universal Series Bus) connector housing, more particularly to a USB connector housing including an engaging pin that has a head portion for anchoring at a periphery of a hole in a board, and a body portion abutting against a hole-defining wall of the hole in the board.

2. Description of the Related Art

As shown in FIGS. 1 and 2, a conventional USB connector housing 100 is to be assembled with a terminal seat 101 and a plurality of conductive terminals 102 for production of a USB connector. The USB connector housing 100 is also to be connected to a board 103 for mounting to a device (not shown).

The board 103 is formed with a plurality of mounting holes 104 for mounting the USB connector housing 100 thereto. The USB connector housing 100 includes a main body 11, a flat guiding pin 12 extending rearwardly from a rear end of the main body 11, and a bifurcated engaging member 13. The guiding pin 12 is adapted to extend through one of the mounting holes 104 in the board 103. The bifurcated engaging member 13 includes a pair of engaging pins 131 that cooperatively define a gap 132 therebetween. Each of the engaging pins 131 has a toothed outer side 133 for abutting against a hole-defining wall of one of the mounting holes 104 so as to secure firmly the USB connector housing 100 to the board 103.

Since frictional engagement between the engaging member 13 and the hole-defining wall of the mounting hole 104 is achieved through the toothed outer sides 133 of the engaging pins 131, the contact area provided by the toothed outer sides 133 is relatively small, which results in a decrease in the friction with the board 103, which, in turn, results in a poor connection between the USB connector housing 100 and the board 103. Hence, the USB connector housing 100 tends to disengage from the board 103 after a period of use.

### SUMMARY OF THE INVENTION

Therefore, the object of the present invention is to provide a USB connector housing that can overcome the aforesaid drawback associated with the prior art.

According to the present invention, there is provided a USB connector housing that is adapted to be connected to a board which has front and rear sides and which is formed with a guiding hole and an engaging hole. The USB connector housing comprises: a hollow main body having a rear open end; a guiding pin extending rearwardly from the rear open end of the main body and adapted to extend through the guiding hole in the board; and an engaging member extending rearwardly from the rear open end of the main body and including a pair of opposite engaging pins adapted to extend through the engaging hole in the board and to abut against a hole-defining wall of the engaging hole. Each of the engaging pins has a free end distal from the rear open end of the main body, inner and outer lateral sides extending rearwardly from the rear open end of the main body to the free end, a leg portion extending rearwardly from the rear open end of the main body and adapted to be disposed at the front side of the board, a body portion extending rearwardly from the leg portion and adapted to abut against the hole defining wall of the engaging hole, a neck portion extending rearwardly and reduced in cross-section from the body portion, and a head portion extending rearwardly and enlarged in cross-section from the neck portion, tapered therefrom to the free end, and adapted to be disposed at the rear side of the board. The inner lateral sides of the engaging pins face each other and cooperatively define a gap therebetween. The neck portion of each of the engaging pins cooperates with the head portion and the body portion to define a recess indented from the outer lateral side. The head portion of each of the engaging pins has an anchor end opposite to the free end and adapted for anchoring at a periphery of the engaging hole in the board. The anchor end of the head portion has a width between the inner and outer lateral sides greater than those of the neck portion and the body portion.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional USB connector housing which is to be assembled with a terminal seat and a plurality of conductive terminals;

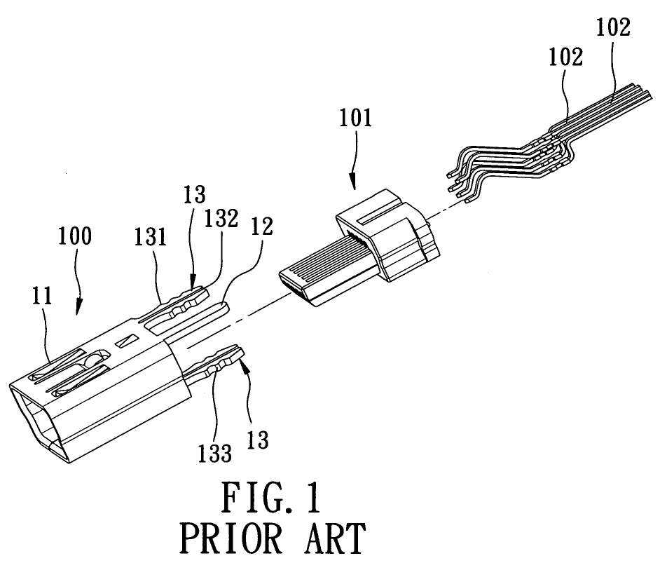

FIG. 2 is a top sectional view to illustrate connection of the conventional USB connector housing to a board;

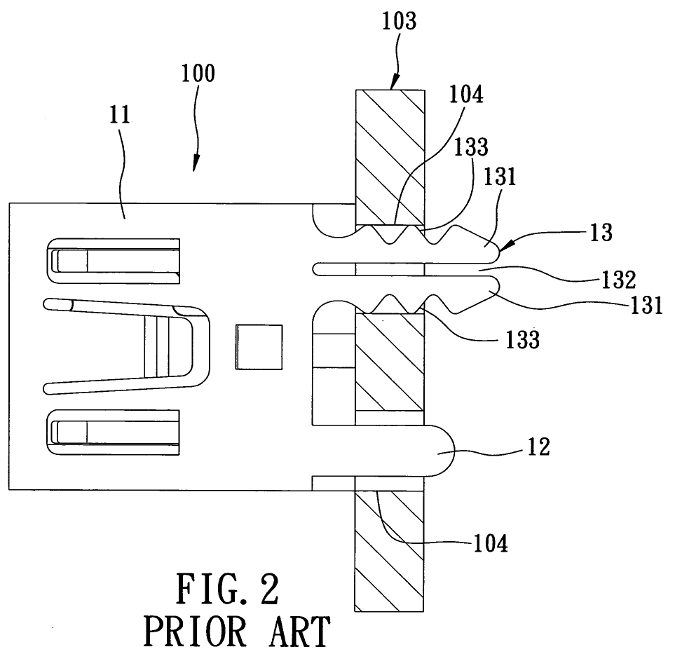

FIG. 3 is an exploded perspective view of the preferred embodiment of a USB connector housing according to the present invention, which is to be assembled with a terminal seat and a plurality of conductive terminals;

FIG. 4 is an assembled perspective view of the preferred embodiment, illustrating how the preferred embodiment is to be connected to a USB plug;

FIG. 5 is a top sectional view illustrating a state where the preferred embodiment engages a thick board; and

FIG. 6 is a top sectional view illustrating another state where the preferred embodiment engages a thin board.

### DETAILED DESCRIPTION OF THE PREFERRED EMBODIMENT

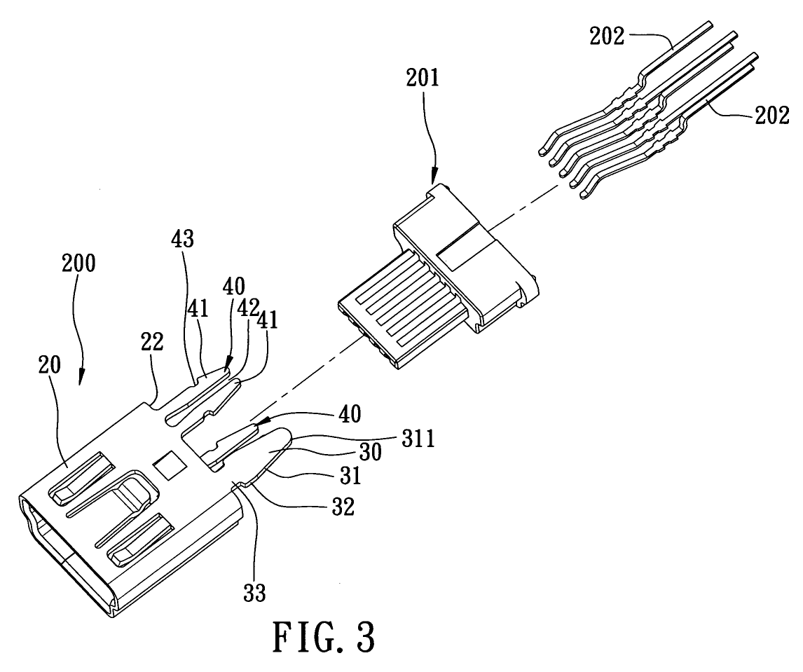

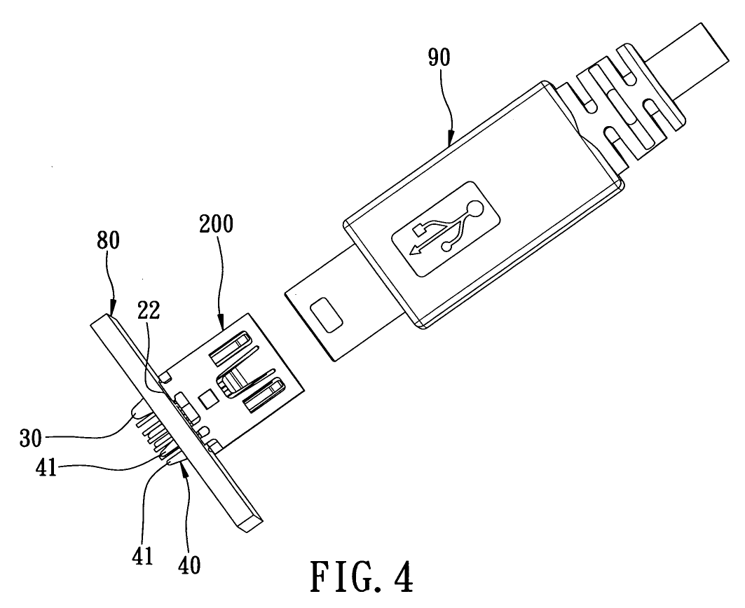

Referring to FIGS. 3, 4 and 5, the preferred embodiment of a USB connector housing 200 according to the present invention is shown to be assembled with a terminal seat 201 and a plurality of conductive terminals 202. The USB connector housing 200 is adapted to be connected to a board 80 so as to be mounted to a device (not shown), and is adapted to be connected to a USB plug 90. The board 80 has front and rear sides, and which is formed with a guiding hole 81 and two engaging holes 82. The USB connector housing 200 includes: a hollow main body 20 having a rear open end 22; a guiding pin 30 extending rearwardly from the rear open end 22 of the main body 20 and adapted to extend through the guiding hole 81 in the board 80; and two engaging members 40 extending rearwardly from the rear open end 22 of the main body 20. Each of the engaging members 40 includes a pair of opposite engaging pins 41 adapted to extend through a respective one of the engaging holes 82 in the board 80 and to abut against a hole-defining wall of the respective engaging hole 82. Each of the engaging pins 41 has a free end 411 distal from the rear open end 22 of the main body 20, inner and outer lateral sides 412, 413 extending rearwardly from the rear open end 22 of the main body 20 to the free end 411, a leg portion 414 extending rearwardly from the rear open end 22 of the main body 20 and adapted to be disposed at the front side of the board 80, a body portion 415 extending rearwardly from the leg portion 414 and adapted to abut against the hole defining wall of the respective engaging hole 82, a neck portion 416 extending rearwardly and reduced in cross-section from the body portion 415, and a head portion 417 extending rearwardly and enlarged in cross-section from the neck portion 416, tapered there from to the free end 411, and adapted to be disposed at the rear side of the board 80. The inner lateral sides 412 of the engaging pins 41 face each other and cooperatively define a gap 42 therebetween. The neck portion 416 of each of the engaging pins 41 cooperates with the head portion 417 and the body portion 415 to define a recess 43 indented from the outer lateral side 413. The head portion 417 of each of the engaging pins 41 has an anchor end 4171 opposite to the free end 411 and enlarged in width from the neck portion 416. The outer lateral side 413 of the anchor end 4171 of the head portion 417 is adapted to anchor at a periphery of the respective engaging hole 82 in the board 80. The anchor end 4171 of the head portion 417 of each of the engaging pins 41 has a width (W) between the inner and outer lateral sides 412, 413 greater than those of the neck portion 416 and the body portion 415.

In this embodiment, the outer lateral side 413 of the body portion 415 of each of the engaging pins 41 is straight. The guiding pin 30 has a first segment 33 extending rearwardly from the rear open end 22 of the main body 20 and adapted to be disposed at the front side of the board 80, a second segment 32 extending rearwardly and enlarged in cross-section from the first segment 33 and adapted to abut against a hole-defining wall of the guiding hole 81, and a third segment 31 extending rearwardly and tapered in cross-section from the second segment 32 and having a free end 311 adapted to be disposed at the rear side of the board 80.

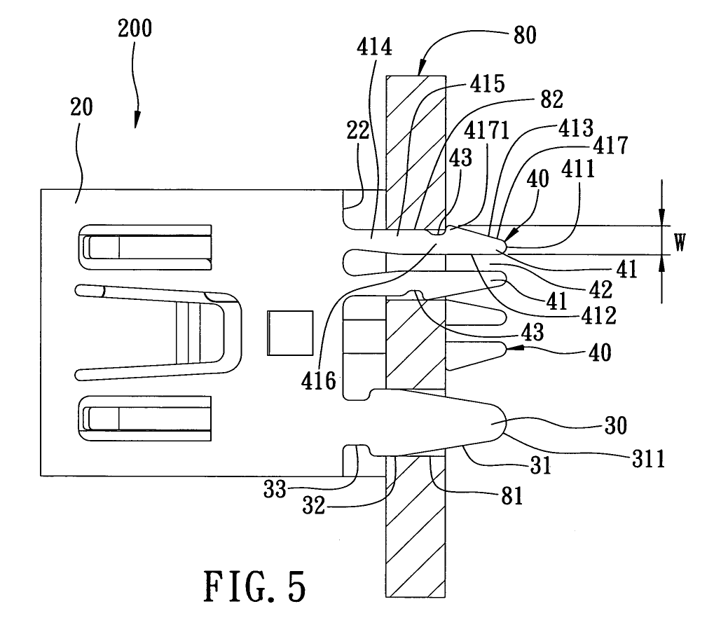

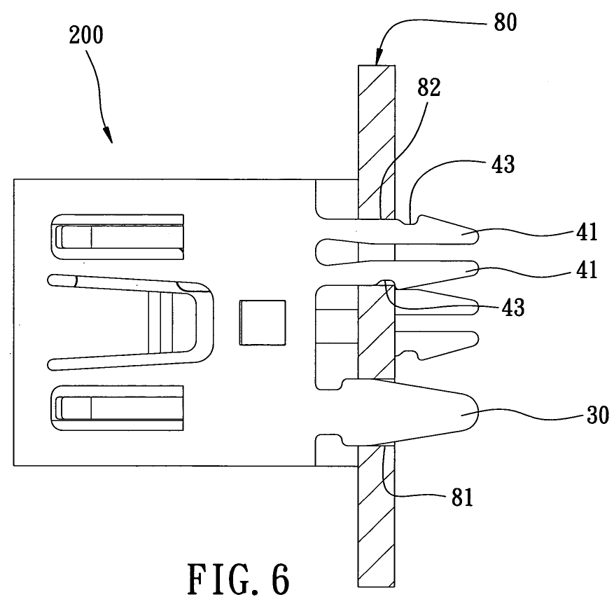

The engaging pins 41 of each of the engaging members 40 are opposite to each other in a transverse direction relative to the length of the respective engaging member 40. The anchor ends 4171 of the head portions 417 of the engaging pins 41 are misaligned along the transverse direction. The arrangement as such permits mounting of the USB connector housing 200 to boards 80 having different thicknesses, as best illustrated in FIGS. 5 and 6. In FIG. 5, the USB connector housing 200 is connected to a thick board 80 having a thickness of 1.6 mm. As such, the anchor end 4171 of the head portion 417 of an outer one of the engaging pins 41 is anchored at the periphery of the respective engaging hole 82, while the anchor end 4171 of the head portion 417 of an inner one of the engaging pins 41 remains in the respective engaging hole 82. In addition, the body portion 415 of the outer one of the engaging pins 41 abuts against the hole-defining wall of the respective engaging hole 82. In FIG. 6, the USB connector housing 200 is connected to a thin board 80 having a thickness of 1.0 mm. As such, the anchor end 4171 of the head portion 417 of the inner one of the engaging pins 41 is anchored at the periphery of the respective engaging hole 82, while the anchor end 4171 of the head portion 417 of the outer one of the engaging pins 41 is disposed outwardly of the respective engaging hole 82.

By forming the anchor end 4171 on each engaging pin 41 of each engaging member 40 of the USB connector housing 200 of this invention, the aforesaid drawback associated with the prior art can be eliminated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A USB connector housing adapted to be connected to a board which has front and rear sides and which is formed with a guiding hole and an engaging hole, said USB connector housing comprising:
a hollow main body having a rear open end;
a guiding pin extending rearwardly from said rear open end of said main body and adapted to extend through the guiding hole in the board; and
an engaging member extending rearwardly from said rear open end of said main body and including a pair of opposite engaging pins adapted to extend through the engaging hole in the board and to abut against a hole-defining wall of the engaging hole, each of said engaging pins having a free end distal from said rear open end of said main body, inner and outer lateral sides extending rearwardly from said rear open end of said main body to said free end, a leg portion extending rearwardly from said rear open end of said main body and adapted to be disposed at the front side of the board, a body portion extending rearwardly from said leg portion and adapted to abut against the hole defining wall of the engaging hole, a neck portion extending rearwardly and reduced in cross-section from said body portion, and a head portion extending rearwardly and enlarged in cross-section from said neck portion, tapered therefrom to said free end, and adapted to be disposed at the rear side of the board, said inner lateral sides of said engaging pins facing each other and cooperatively defining a gap therebetween, said neck portion of each of said engaging pins cooperating with said head portion and said body portion to define a recess indented from said outer lateral side, said head portion of each of said engaging pins having an anchor end opposite to said free end and adapted for anchoring at a periphery of the engaging hole in the board, said anchor end of said head portion having a width between said inner and outer lateral sides greater than those of said neck portion and said body portion.

2. The USB connector housing as claimed in claim 1, wherein said outer lateral side of said body portion of each of said engaging pins is straight.

3. The USB connector housing as claimed in claim 1, wherein said guiding pin has a first segment extending rearwardly from said rear open end of said main body and adapted to be disposed at the front side of the board, a second segment extending rearwardly and enlarged in cross-section from said first segment and adapted to abut against a hole-defining wall of the guiding hole, and a third segment extending rearwardly and tapered in cross-section from said second segment and having a free end adapted to be disposed at the rear side of the board.

4. The USB connector housing as claimed in claim 1, wherein said engaging pins are opposite to each other in a transverse direction relative to the length of said engaging member, said anchor ends of said head portions of said engaging pins being misaligned along the transverse direction.
